(19) United States
(12) Patent Application Publication
(10) Pub. No.: US 2006/0103720 A1
(43) Pub. Date: May 18, 2006

(54) Scanning apparatus using light source performing on/off operation

(75) Inventor: Gi Lyong Na, Kyunggi-Do (KR)

Correspondence Address: DARBY & DARBY P.C., P. O. BOX 5257, NEW YORK, NY, 10150-5257, US

(73) Assignee: Samsung Electro-Mechanics Co., Ltd., Kyunggi-do (KR)

(21) Appl. No.: 11/115,986

(22) Filed: Apr. 27, 2005

(30) Foreign Application Priority Data
Nov. 16, 2004 (KR) 2004-93593

(51) Int. Cl. B41J 15/14; B41J 27/00

(52) U.S. Cl. 347/241

(57) ABSTRACT

The present invention relates, in general, to a scanning apparatus using a diffractive light modulator and, more particularly, to a scanning apparatus, which turns on or off a laser diode, used as a light source, in synchronization with the operating frequency of a diffractive light modulator used in a laser printer, projector, etc., thus eliminating distortion of light spots formed on a scanning object. The diffractive scanning apparatus of the present invention includes a light generation processing means, a light modulation processing means, and a scanning means.

### BACKGROUND OF THE INVENTION

1. Field of the Invention

The present invention relates, in general, to a scanning apparatus using a diffractive light modulator and, more particularly, to a scanning apparatus, which turns on or off a laser diode, used as a light source, in synchronization with the operating frequency of a diffractive light modulator used in a laser printer, projector, etc., thus eliminating distortion of light spots formed on a scanning object.

2. Description of the Related Art

Among recently popularized printers, a laser printer has attracted attention due to printing speed and quality higher than that of an ink-jet printer in the monochrome printer field.

FIG. 1 is a view showing a conventional scanning apparatus using a light modulator for a laser printer.

Referring to FIG. 1, if a laser diode 11 generates a laser beam, a collimator lens 12 converts the laser beam into collimated light, and converges the collimated light onto a multi-beam control light modulator 13.

The multi-beam control light modulator 13 diffracts and modulates the laser beam, converted into the collimated light, and outputs a plurality of (N) beams. A projection lens 15 converges the plurality of diffracted beams in the direction of the shaft of a rotating mirror 14.

In this case, if a slit 18 is disposed between the multi-beam control light modulator 13 and the rotating mirror 14, the slit 18 selectively passes therethrough beams having desired properties among the beams diffracted by the multi-beam control light modulator 13, thus transmitting the selected beams to the rotating mirror 14.

The diffracted beams, converged in this way, scan a drum 17 or a scanning object using a polygon mirror that moves at a constant linear velocity, or using a Galvano mirror that moves at a non-constant linear velocity.

At this time, the rotational speed of the rotating mirror 14 can be decreased in proportion to the number of beams output from the light modulator 13.

Accordingly, if the rotating mirror 14 is implemented as a polygon mirror, an F-θ lens 16 deflects the diffracted beams, reflected from the polygon mirror and moved at a constant angular velocity, in a main scanning direction, corrects aberration of the diffracted beams, and focuses and irradiates the aberration-corrected beams onto the surface of the photosensitive drum 17 or the scanning object.

If the rotating mirror 14 is implemented as a Galvano mirror, the F-θ lens 16 deflects the diffracted beams, reflected from the Galvano mirror and moved at a constant angular velocity, in a main scanning direction, corrects aberration of the diffracted beams, and focuses and irradiates the aberration-corrected beams onto the surface of the photosensitive drum 17 or the scanning object.

Among recently popularized printers, a laser printer has attracted attention due to higher printing speed and printing quality than that of an ink-jet printer. However, there is a limitation in increasing a printing speed using a current printing method, so that a new laser printing scheme is required. Therefore, the laser printing scheme using the light modulator of FIG. 1 has been proposed as the solution to the limitation. However, since the light modulator has a mechanical structure, the operational speed thereof is lower than the electrical operational speed of a laser diode.

FIG. 2A is a view showing the operating waveform of a laser diode used as a light source in a conventional scanning apparatus, and FIG. 2B is a view showing the operating waveform of micromirrors constituting a light modulator used as a light modulation means in the conventional scanning apparatus.

As shown in FIGS. 2A and 2B, a light source in the conventional scanning apparatus using a light modulator is always turned on during the operation of the scanning apparatus, and the light modulator scans a photosensitive drum with light while a plurality of mirrors, constituting the light modulator, are repeatedly turned or off. That is, the light source is always turned on, and the scanning speed is determined by the operational speed of the light modulator.

Light spots shown in FIG. 3A are formed by the operation of the light modulator. However, an optical image actually formed on the photosensitive drum is deformed to an image having a horizontally stretched shape as shown in FIG. 3B on the photosensitive drum due to the rotation of the photosensitive drum and the shift of a scanning direction caused by the polygon mirror, etc. for a period during which the light modulator is turned on. That is, nearly circular light spots are formed by the light modulator, but, actually, images stretched in the scanning direction or the rotating direction of the photosensitive drum as shown in FIG. 3B are formed on the scanning object due to the rotation or movement of the scanning object or to a reflection device, such as the polygon mirror.

Since scanned light is not formed on the scanning object without being changed, the quality of a final image composed of several million pixels is inevitably decreased.

When the rotational speed of a polygon mirror, which is a reflection device for reflecting incident light and transmitting the reflected light to a scanning object while rotating at a constant speed, is increased, or when the rotational speed of a photosensitive drum, which is the scanning object of the laser printer, is further increased, the pixels formed on the surface of the photosensitive drum are horizontally stretched and overlap with other pixels, so that a final image may be crushed or broken.

Further, since there is a limitation in increasing the operational speed of a light modulator in which a plurality of mirrors are operated, it is difficult to increase the scanning speed, however high the operational speed of other devices, such as a laser diode.

In relation to this scheme, U.S. Pat. No. 6,025,859 discloses a laser printer using two light modulators to increase the printing speed. The laser printer proposed in the patent supports a high printing speed, however, a light source is always turned on, and the above-described problem occurring at the time of high-speed printing remains unsolved.

### SUMMARY OF THE INVENTION

Accordingly, the present invention has been made keeping in mind the above problems occurring in the prior art, and an object of the present invention is to provide a laser scanning apparatus, which uses a laser diode, repeatedly turned on or off at a frequency synchronized with that of a light modulator, as a light source, thus improving the quality of an image while operating at a high operational speed.

In order to accomplish the above object, the present invention provides A diffractive scanning apparatus using a light source performing an on/off operation, comprising light generation processing means for generating light turned on or off at a predetermined frequency, converting the light into collimated light, and emitting the collimated light; light modulation processing means operated in synchronization with an operating frequency of the light generation processing means, and adapted to diffract and modulate the collimated light, emitted from the light generation processing means, and output and converge a plurality of diffracted beams; and scanning means for moving and reflecting the plurality of diffracted beams, converged by the light modulation processing means, at a constant linear velocity or non-constant linear velocity, deflecting the plurality of diffracted beams that are reflected and moved at a constant angular velocity or non-constant angular velocity, in a main scanning direction, correcting aberration of the beams, and scanning a surface of a scanning object with the aberration-corrected beams while focusing the beams onto the surface.

### BRIEF DESCRIPTION OF THE DRAWINGS

FIG. 1 is a view showing a conventional scanning apparatus for a laser printer using a light modulator;

FIG. 2A is a view showing the operating waveform of a light source in a conventional scanning apparatus and FIG. 2B is a view showing the operating waveform of a light modulation means in the conventional scanning apparatus;

FIGS. 3A and 3B are views showing a problem occurring in the conventional scanning apparatus; and

FIG. 4 is a view showing the operation of a light modulator and a light source, and image patterns formed thereby, in a scanning apparatus according to the present invention.

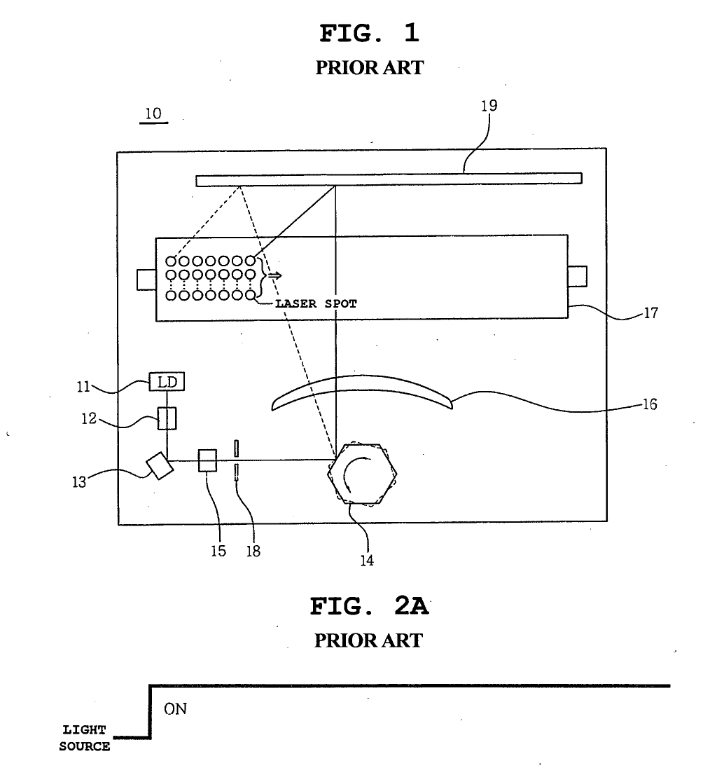

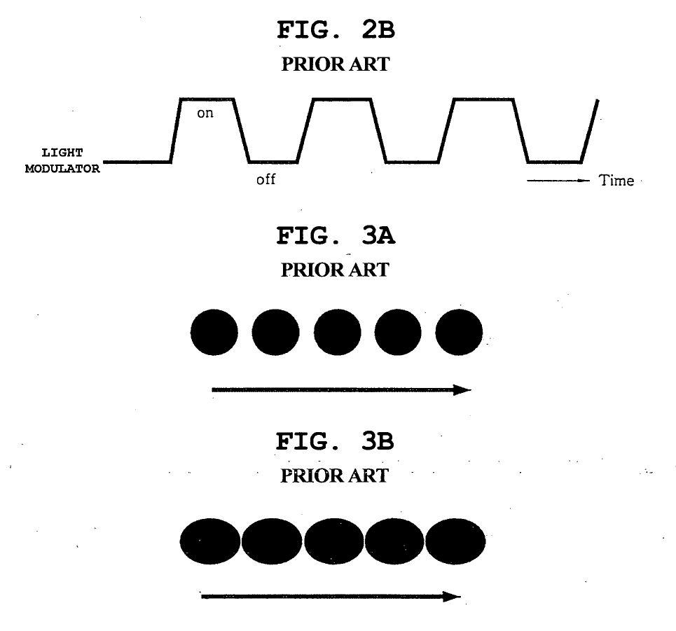

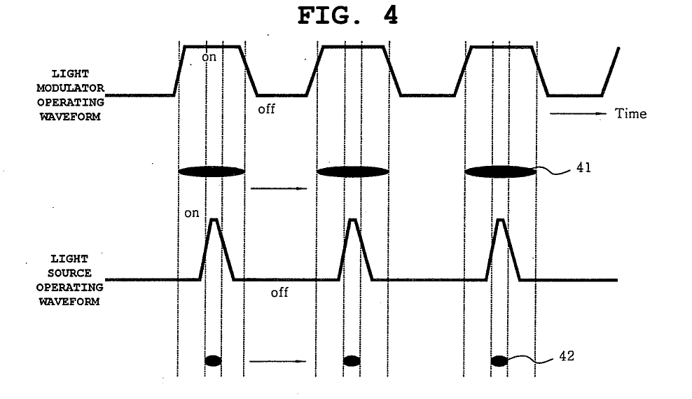

### DESCRIPTION OF THE PREFERRED EMBODIMENTS

Hereinafter, embodiments of the present invention will be described in detail with reference to the attached drawings.

Reference now should be made to the drawings, in which the same reference numerals are used throughout the different drawings to designate the same or similar components.

FIG. 4 is a view showing the operation of a light modulator and a light source, and image patterns formed thereby, in a scanning apparatus according to the present invention.

On an upper portion of FIG. 4, the waveform of a reference operating frequency of a light modulator that is repeatedly turned on or off at a constant frequency is shown. The light modulator is composed of 1080 or 1920 fine pixel units arranged in a line, and each pixel unit scans a single pixel on a scanning object and includes 4, 6 or more micromirrors.

Respective micromirrors are driven by an applied voltage, so that a single pixel unit generates +1st or −1st-order light by diffracting incident collimated light when it is turned on, and reflects incident light without change when it is turned off. Alternatively, it is possible for a single pixel unit to reflect incident light without change when it is turned on, and to generate +1st-order light or −1st-order light when it is turned off. In this embodiment, a slit is disposed at the location from which +1st-order or 0th-order light is reflected, and light is selected.

Each micromirror performs an on or off operation in response to an input signal according to the operating waveform of the light modulator shown in the upper portion of FIG. 4. Light generated by the laser diode through the on or off operation is diffracted to several thousand pixels by the light modulator.

In the lower portion of FIG. 4, the operating waveform of a laser diode used as a light generation means in the diffractive scanning apparatus according to the present invention is shown. As shown in FIG. 4, the diffractive scanning apparatus of the present invention turns on or off a laser diode, which is used as a light generation means in a laser printer using a light modulator, at a constant frequency. The light generated by the light generation means is converted into collimated light by a collimator lens, etc. and is transmitted to a light modulation processing means.

In this case, the operating frequency of the laser diode is synchronized with the operation of a plurality of micromirrors constituting the light modulator.

The laser diode is constructed to allow the on time thereof to be shorter than that of the light modulator, in addition to the synchronization of the on/off operational speed of the laser diode with the operating frequency of the light modulator. The on time of the laser diode is shorter than the off time thereof.

The on/off operation of the laser diode can be performed by a switching device capable of turning the laser diode on or off at a constant frequency.

The light scanned by the light modulator passes through a polygon mirror and a plurality of lenses, and is then focused on the photosensitive drum. In this case, if the laser diode is always turned on, as in the conventional scheme, spots 41, each having a shape that is stretched in the scanning direction of diffracted light or the movement direction of a scanning object, are formed, as shown in FIG. 4.

In contrast, if the operating frequency of the laser diode is synchronized with that of the light modulator, and the on time of the laser diode is shortened, corrected spots 42, each formed by cutting out both side portions of each spot 41, are formed on the photosensitive drum.

The pixels formed by the corrected spots 42 do not have the possibility of overlapping with other pixels due to the rotation of a photosensitive drum or a reflection device, such as a polygon mirror. Accordingly, a problem in which pixels overlap with each other and an image formed by the pixels is broken can be solved even though the rotational speed of the photosensitive drum or the polygon mirror is increased.

This construction can be applied to all scanning apparatuses, using a diffractive light modulator, such as a projector or High Definition Television (HDTV), in addition to the laser printer.

As described above, the present invention provides a scanning apparatus using a light source performing an on/off operation, which can improve the quality of an image while operating at a high operational speed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A diffractive scanning apparatus using a light source performing an on/off operation, comprising:
light generation processing means for generating light turned on or off at a predetermined frequency, converting the light into collimated light, and emitting the collimated light;
light modulation processing means operated in synchronization with an operating frequency of the light generation processing means, and adapted to diffract and modulate the collimated light, emitted from the light generation processing means, and output and converge a plurality of diffracted beams; and
scanning means for moving and reflecting the plurality of diffracted beams, converged by the light modulation processing means, at a constant linear velocity or non-constant linear velocity, deflecting the plurality of diffracted beams that are reflected and moved at a constant angular velocity or non-constant angular velocity, in a main scanning direction, correcting aberration of the beams, and scanning a surface of a scanning object with the aberration-corrected beams while focusing the beams onto the surface.

2. The diffractive scanning apparatus according to claim 1, wherein the light generation processing means has an on time shorter than that of the light modulation processing means.
